(19) United States
(12) Patent Application Publication
(10) Pub. No.: US 2008/0102419 A1
(43) Pub. Date: May 1, 2008

(54) Control Device for the Drive of a Dental Handpiece Operated with a Regulated Electric Motor

(75) Inventors: Johannes Sauter, Mittelbuch (DE); Richard Buerk, Alberweiler (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Kaltenbach & Voigt GmbH, Biberach (DE)

(21) Appl. No.: 11/928,134

(22) Filed: Oct. 30, 2007

(30) Foreign Application Priority Data
Oct. 31, 2006 (DE) 10 2006 051507.2

(51) Int. Cl. A61C 1/02

(52) U.S. Cl. 433/99

(57) ABSTRACT

The invention relates to a control device for the drive of a dental handpiece operated with a regulated electric motor. So that a dentist has an acoustic feedback concerning the loading of a tooth worked with the dental handpiece, the control device is so configured that a speed of rotation characteristic dependent on the load of the electric motor, starting from an initial point, falls with increasing motor current or increasing power, wherein at least one of the initial point, the inclination, and the development of the falling characteristic is selectable.

### BACKGROUND OF THE INVENTION

1. Field of the Invention

The invention relates generally to a device for controlling the drive of a handpiece, particularly a dental handpiece, operated with a regulated electric motor.

2. Related Technology

With a dental handpiece operated with non-regulated electric motor the speed of rotation of the electric motor falls with increasing load. This effect is undesired, at least when the fall is so strong that the cutting effect of the tool is negatively affected. However, the dentist has acoustic feedback concerning the material removal power exerted on the tooth through the changing speed of rotation, because the human ear reacts very sensitively to the frequency changes which are caused by changes of the speed of rotation.

More recently, dental handpieces have been operated only with electric motors having regulated speed of rotation. With these the danger exists, however, that at the site of the tooth being worked overheating, and with that damage to the tooth, occurs if the load due to corresponding pressure of the dental handpiece against the tooth becomes too large or lasts too long.

### SUMMARY OF THE INVENTION

The invention provides the dentist with acoustic feedback concerning the load also with dental handpieces with a regulated electric motor.

According to the invention, the control device for the drive of a dental handpiece operated with a regulated electric motor is so constituted that a speed of rotation characteristic, dependent on the load of the electric motor, falls—starting from an initial point—with increasing motor current or increasing power, wherein at least one of the initial point, the inclination, and the development of the falling characteristic is selectable.

Unlike the naturally falling characteristic in the case of non-regulated electric motors, a completely determined falling characteristic can purposefully be set according to the invention. The dentist can select and set this characteristic according to the different modes of working and his personal perception.

### BRIEF DESCRIPTION OF THE DRAWINGS

An embodiment of the invention will be described below with reference to the drawings.

FIG. 1 shows a dental handpiece provided with a regulated electric motor, and the associated control device; and,

FIG. 2 shows different characteristics with selectively settable variations.

### DETAILED DESCRIPTION

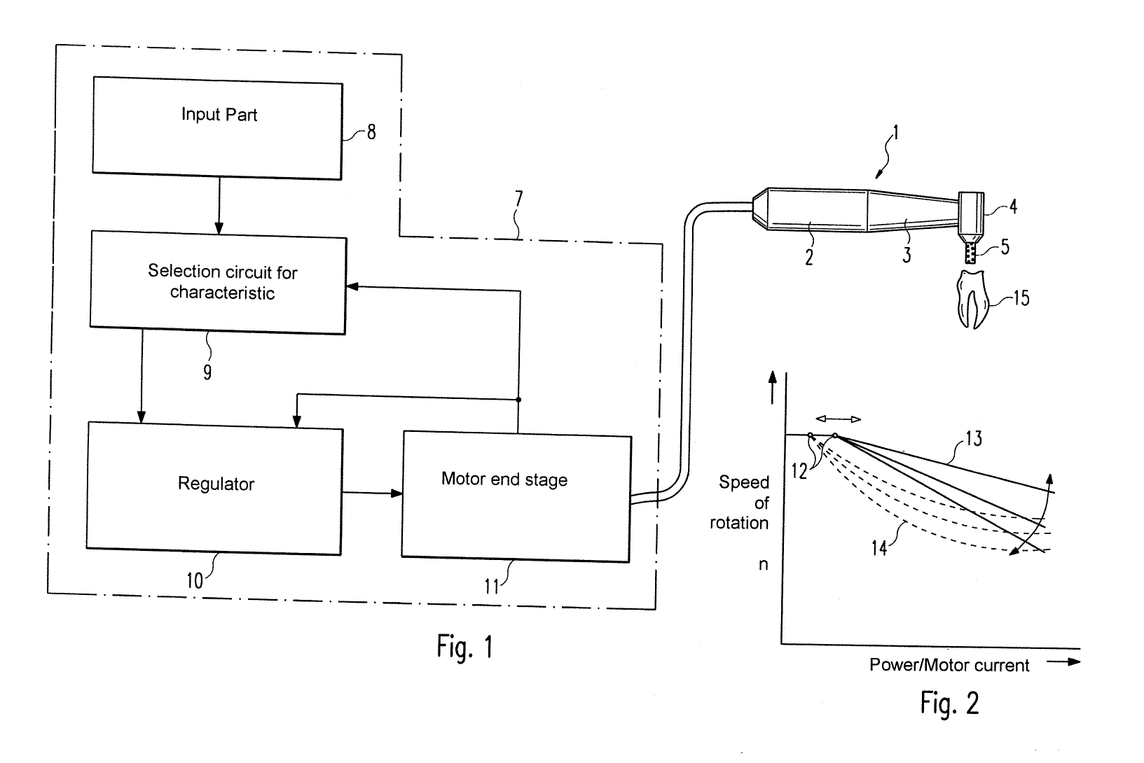

FIG. 1 shows a dental handpiece 1 with a motor part 2 containing an electric motor and a fixture part 3 on which there is located a head 4 with a rotary tool 5. The dental handpiece 1 is connected to a control device 7 via a supply line or hose 6.

The control device 7 includes an input part 8 into which information about the motor characteristic can be entered. This information is passed on in appropriate form as signals to a selection circuit 9 for the characteristic. In the selection circuit 9 different characteristic types are stored and which are modified in a desired manner by the data entered into the input part 8. The modified and selected characteristic is passed on by the selection circuit 9 as a desired value to a regulator 10, which delivers a setting value signal to a motor final or end stage 11. The motor end stage 11 then supplies, via the supply line 6, the electric motor with the motor current. The actual value is delivered to the regulator 10 from the motor end stage 11. In addition, the actual value is delivered to the selection circuit 9 for the characteristic, for desired value formation.

If the dental handpiece 1 is placed with its rotary tool 5 on a tooth 15, then the motor current and thus also the power of the electric motor necessarily increases.

The characteristic shown in FIG. 2 concerning the dependence of the speed of rotation upon the motor current or the power shows that the speed of rotation—starting out from an initial point 12—falls with increasing power. The dentist can now select by means of corresponding data which he enters into the input part 8 a determined characteristic type. In FIG. 2 there are shown two different characteristic types 13 and 14 which can be varied by alteration of the inclination. The variations of inclination can also be preselected by a corresponding input at the input part 8. Further the initial point 12 at which the characteristic fall off begins can be pre-selected by the dentist.

In FIG. 1 the solution in accordance with the invention is illustrated as a hardware solution for better understanding. However, several or all blocks can be combined to a single block and the realization of the fundamental concept of invention effected in terms of software.

1. Control device for the drive of a dental handpiece operated with a regulated electric motor, wherein a speed of rotation characteristic dependent on the load of the electric motor, starting from an initial point, falls with increasing motor current or increasing power, wherein at least one of the initial point, the inclination, and the development of the falling characteristic is selectable.

2. Control device of claim 1, wherein two or more of the initial point, the inclination, and the development of the falling characteristic is selectable.

3. Control device of claim 1, wherein each of the initial point, the inclination, and the development of the falling characteristic is selectable.

4. Control device of claim 1, wherein the handpiece comprises an electric motor and a fixture having a head for holding a rotary tool, and the control device comprises an input into which information about a motor characteristic may be entered, a selection circuit for storing and modifying different types of the motor characteristic based on information received from the input, a regulator which receives characteristic information from the selection circuit and delivers a setting value signal to control a motor end stage, which communicates with the electric motor by a supply line.
